(19) United States
(12) Patent Application Publication
(10) Pub. No.: US 2006/0285085 A1
(43) Pub. Date: Dec. 21, 2006

(54) Projection-type display apparatus with wide color reproduction area in any gray scale level

(76) Inventors: Shoichi Hirota, Hitachi (JP); Tsunenori Yamamoto, Hitachi (JP); Katsumi Kondo, Mito (JP); Akitoyo Konno, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/452,982

(22) Filed: Jun. 15, 2006

(30) Foreign Application Priority Data
Jun. 17, 2005 (JP) 2005-177113

(51) Int. Cl. G03B 21/20

(52) U.S. Cl. 353/85

(57) ABSTRACT

A projection-type display apparatus includes at least one light source for emitting three primary color lights, a display panel, a control circuit for controlling the display panel, an illumination light optical system for illuminating the display panel with the light emitted from the light source, and a projection lens for projecting the light modulated by the display panel. The illumination light quantity is modulated by a control signal generated according to a video signal in at least one of the illumination color lights among the three primary color lights and the upper limit of the dynamic range of the display panel is used without depending on the video signal.

### BACKGROUND OF THE INVENTION

The present invention relates to a projection-type display apparatus for enlarging and projecting video displayed on a micro display panel.

Explanation will be given on the conventional projection-type display apparatus/

The main projection-type display device for television has been a CRT (Cathode Ray Tube) type. However, with implementation of high-definition television broadcast, a projection type display apparatus using a fixed pixel micro display as a display panel is appearing in market. The conventional example of the projection-type display apparatus of the micro display type is disclosed in JP-A-8-304739. Other prior arts associated with the present invention are disclosed in JP-A-2002-303931 and U.S. Pat. No. 6,678,078.

### SUMMARY OF THE INVENTION

When the illumination quantity of the display panel is not controlled as in the conventional projection-type display apparatus, for example, if the blue and the green gradation are 0 and the red gradation is modulated in an arbitrary way, the chromaticity characteristic is such that the color purity is lowered as the red gradation is lowered. This is because when the liquid crystal panel gradation is 0, i.e., black display, a slight light is projected actually and the affect cannot be ignored as the gradation of the main color is lowered.

Alternatively, when the white light is entirely controlled in the quantity of the light incident to the liquid crystal panel, the quantity of light incident to the display panel can be minimized only when all the color gradations are 0, i.e., black display. It is possible to reduce the leaking light during black display. However, for example, when the blue and the green gradation are 0 and the red gradation is modulated in an arbitrary way, the quantity of each light incident to the display panel depends on the red gradation. Accordingly, when the red is displayed with low gradation, mixing of the green and blue light cannot be prevented completely.

It is therefore an object of the present invention to provide a projection-type display apparatus using a micro display as a display panel capable of preventing mixture of other colors upon displaying an arbitrary color with low gradation and improving a color reproduction range in all the gradations.

In order to achieve the aforementioned object, the present invention provides a configuration including a light source emitting three primary colors, a display panel, a control circuit for controlling the display panel, an illumination optical unit for illuminating the display panel with the light emitted from the light source, an illumination light quantity control element for modulating the illumination light quantity of each of the three primary colors, and a projection lens for projecting the light modulated by the display panel, wherein the control circuit generates a control signal for controlling the display panel according to an inputted video signal, the illumination light quantity control element modulates the illumination light quantity according to the control signal at least in one of the illumination lights of the three primary color lights, and the illumination light quantity is modulated by using the upper limit of the dynamic range of the display panel not depending on the video signal.

According to another aspect of the inventions, the configuration further includes a color separation optical unit for separating the three primary color lights into red, green, and blue primary color lights, wherein the illumination light quantity control element is arranged on the optical path of at least one of the three primary colors at a position before each color light separated by the color separation optical unit comes into the display panel.

According to still another aspect of the invention, there is provided a configuration including a light source emitting three primary colors, a liquid crystal panel, a control circuit for controlling the liquid crystal panel, an illumination optical unit for illuminating the liquid crystal panel with the light emitted from the light source, a plurality of illumination light quantity control elements for modulating the illumination light quantity of each of the three primary colors, and a projection lens for projecting the light modulated by the liquid crystal panel, wherein the control circuit generates a control signal for controlling the liquid crystal panel according to an inputted video signal, the illumination light quantity control elements separate the three primary color light into red, green, and blue color lights, modulates the illumination light quantity according to the control signal in each color light separated, uses the upper limit of the dynamic range of the liquid crystal panel not depending on the video signal.

According to yet another aspect of the invention, the configuration further includes a scroll illumination optical system for each color light of the three primary color lights to irradiate different parts of the liquid crystal panel and shift the illumination positions as the time elapses.

According to still yet another aspect of the invention, the light source is formed by light emitting diodes arranged in an array for each of the three primary colors.

Since it is possible to improve the color reproduction range in all the gradations by preventing mixture of other colors during display of an arbitrary color with low gradation, it is possible to provide a projection-type display apparatus capable of performing color reproduction faithful to an original image.

Other objects, features and advantages of the invention will become apparent from the following description of the embodiments of the invention taken in conjunction with the accompanying drawings.

### BRIEF DESCRIPTION OF THE DRAWINGS

FIG. 1 shows a projection-type display apparatus according to an embodiment of the present invention.

FIG. 2 shows an example of a control circuit of the projection-type display apparatus according to the present invention.

FIG. 3 shows a projection-type display apparatus according to another embodiment of the present invention.

FIG. 4 shows a projection-type display apparatus according to still another embodiment of the present invention.

FIG. 5A to FIG. 5C show scroll illumination of the illumination light raster of the projection-type display apparatus according to the present invention.

FIG. 6A to FIG. 6C show an example of a processing result of an image signal in the projection-type display apparatus of FIG. 4.

FIG. 7A to FIG. 7C show another example of a processing result of an image signal in the projection-type display apparatus of FIG. 4.

FIG. 8 shows another example of the control circuit of the projection-type display apparatus according to the present invention.

FIG. 9 shows a projection-type display apparatus according to yet another embodiment of the present invention.

FIG. 10 is a cross-sectional view of a holographic grating element in the projection-type display apparatus according to the present invention.

FIG. 11 shows a projection-type display apparatus according to still yet another embodiment of the present invention.

FIG. 12 shows an example of application of an LED to the light source in the projection-type display apparatus according to the present invention.

### DETAILED DESCRIPTION OF THE EMBODIMENTS

Description will now be directed to embodiments of the present invention with reference to the attached drawings.

[Embodiment 1]

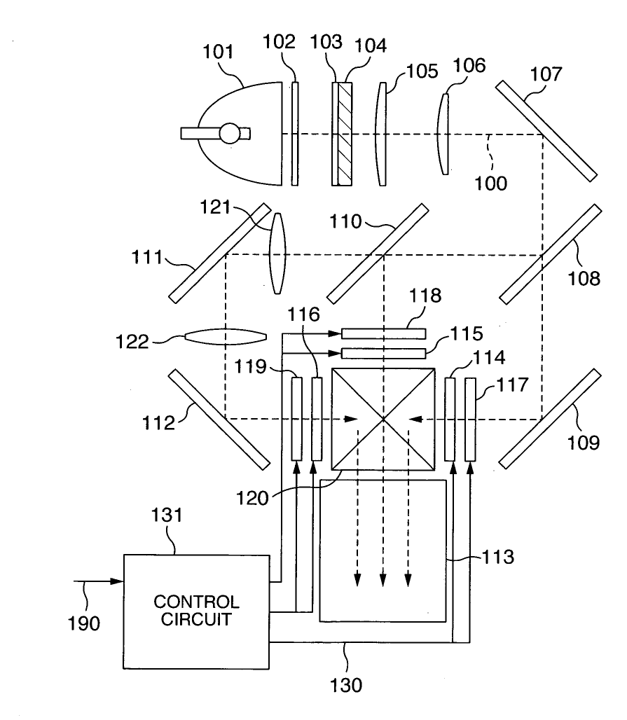

FIG. 1 schematically shows a 3-plate type projection-type display apparatus according to a first embodiment.

The projection-type display device according to the present embodiment is formed by at least: a light source 101; an illumination optical unit having multi-lenses 102 and 103, a polarization beam splitter array 104, and lenses 105 and a106; a mirror 107; dichroic mirrors 108 and 110; mirrors 109, 111, 112; lenses 121, 122; cross dichroic prism 120; a projection lens 113; a plurality of illumination light quantity control elements 117, 118, 119; liquid crystal panels 1114, 115, 116; and a control circuit 131 for controlling the illumination light quantity control elements 117, 118, 119 by a control signal 130.

The white light 100 of the three primary colors emitted from the light source 101 is polarized/converted by the multi-lenses 102, 103 and the polarization beam splitter array 104.

The white light 100 polarized/converted comes into the dichroic mirror 108 via the lenses 105 and 106 and the mirror 107. The light is separated into the red color light and cyan color light by the dichroic mirror 108. The red color light is reflected by the mirror 109 and comes into the illumination light quantity control element 117. The cyan color light is separated into the green color light and the blue color light by the dichroic mirror 110. The green color light comes into the illumination light quantity control element 118.

The illumination optical unit irradiates the liquid crystal panels 114, 115, and 116 with the light emitted from the light source.

The dichroic mirror 108 and the dichroic mirror 110 constitute a color separation optical unit for separating the white light into the three primary color lights: the red, the green, and the blue color light.

The blue color light comes into the illumination light quantity control element 119 via the lens 121, mirror 111, the lens 122, and the mirror 112. The red color light, the green color light, and the blue color light which have passed through the illumination light quantity control elements 117, 118, 119 come into the liquid crystal panels 114, 1115, 116 as display panels, respectively. The liquid crystal panels 114, 115, and 116 are transmission-type liquid crystal panels including at least an active matrix substrate having pixels arranged in a matrix and driven by a transistor as a thin-film semiconductor formed by high-temperature polysilicon, a transparent substrate having a transparent common electrode, and a twist nematic liquid crystal layer sandwiched by the two substrates.

Moreover, the liquid crystal panels 114, 115, 116 have a polarization plate on their both sides. The red color light, the green color light, and the blue color light which have been subjected to image modulation by the liquid crystal panels 114, 115, 116 are color-combined by the cross dichroic prism 120 and projected by the projection lens 113.

The liquid crystal panels 114, 115, 116 and the illumination light quantity control elements 117, 118, 119 are controlled by a control signal 140 generated in the control circuit 131 according to the inputted video signal 10.

The illumination light quantity control elements 117, 118, 119 modulate the respective illumination light intensities of the three primary color lights and are arranged on an optical path of at least one color of the three primary color lights before the respective color lights color-separated by the color separation optical unit come into the liquid crystal panels 114, 115, 116 as display panels.

As a specific configuration example of the illumination light quantity elements 117, 118, 119, there is a liquid crystal cell formed by a liquid crystal layer sandwiched two glass substrates having transparent electrodes.

A polarization plate may be arranged before and after the liquid crystal cell. The polarization plate of the incident side may be omitted because the incident light is polarized in advance by the polarization/conversion optical system including the multi-lenses 102 and 103 and the polarization beam splitter array 104. The polarization plate of the outgoing side may be substituted by the polarization plate arranged at the incident side of the liquid crystal panel and can be omitted.

It is possible to use a liquid crystal layer obtained by nematic liquid crystal subjected to homogeneous orientation, homeotropic orientation, or twist nematic orientation. Alternatively, it is possible to use a ferrodielectric liquid crystal cell. When using a cell of nematic liquid crystal subjected to homogenous orientation, the liquid crystal orientation direction is set to 45 degrees with respect to the incident polarization direction.

The liquid crystal layer thickness is set to substantially half-wavelength retardation with respect to the wavelength range of the incident light.

Explanation will be given on the blue color illumination light. The white color light 100 reflected by the mirror 107 is separated into the red color light and the cyan color light by the dichroic mirror 108. The cyan color light is further separated into the green color light and the glue color light by the dichroic mirror 110. The blue color light comes into the illumination light quantity control element 119 via the lenses 121, 1122 and the mirrors 111, 112.

When a sufficient voltage is applied to the illumination light quantity control element 119, the liquid crystal layer is substantially homeotropically oriented and retardation becomes substantially zero. The polarization state of the polarized light incident to the illumination light quantity control element 119 comes into the liquid crystal panel 116 almost without being changed.

On the other hand, when a low voltage is applied to the illumination light quantity control element 119, the liquid crystal layer is substantially homogeneously oriented and retardation becomes substantially half wavelength. The liquid crystal orientation direction is 45 degrees with respect to the polarization direction of the incident polarized light. Accordingly, the polarization direction of the incident polarized light is rotated by 90 degrees. The illumination light is absorbed by the polarization plate of the light source side of the liquid crystal panel 116 and does not come into the liquid crystal layer of the liquid crystal panel 116.

Thus, by controlling the voltage applied to the illumination light quantity control element 119, it is possible to modulate the transmittance of the incident light through the polarization plate of the light source side of the liquid crystal panel 116 in an analog way. The same functions can be obtained for the illumination light quantity control elements 117, 118 corresponding to the illumination light of the red color and the green color.

Moreover, relationship between the polarization direction of the illumination light before coming into the illumination light quantity control element and the polarization plate of the light source side of the liquid crystal panel may be rotated by 90 degrees in advance. In this case, if the voltage applied to the illumination light quantity control element is low, the illumination light transmits through the polarization plate of the light source side of the liquid crystal panel. If the voltage applied is high, the illumination light is absorbed.

Alternatively, by controlling the voltage applied to the illumination light quantity control elements 117, 118, 119 in a digital way, it is possible to perform time width modulation. When performing a time width modulation, if ferrodielectric liquid crystal layer is used as the liquid crystal layer of the illumination light quantity control elements 117, 118, 119, the optical response becomes 1 ms or below and it is possible to perform accurate control.

By employing the present invention, it is possible to increase the absorption quantity of the incident light at the polarization plate arranged at the side where the illumination light of the liquid crystal panels 114, 115, 116 come (hereinafter, referred to as the incident side polarization plate) as compared to the conventional method. In the conventional method, the polarization direction is parallel to the transmittance axis of the incident side polarization plate and the absorption at the incident side polarization plate is small and heating can be suppressed.

On the other hand, in the present invention, there may be a case when substantially all the light of the illumination light is absorbed by the incident side polarization plate depending on the video signal. The light absorbed is converted into heat and the temperature of the incident side polarization plate may be significantly increased depending on the video signal as compared to the conventional method. Accordingly, when the present invention is employed, sufficient consideration should be taken on the heat resistance of the incident side polarization plate. To solve this problem, there is a method employing a reflection/transmittance-type polarization plate as the incident side polarization plate.

An example of the reflection/transmittance type polarization plate is a wire grid type polarization plate. More specifically, the polarization plate is an optical element formed by a transparent substrate on which a metal thin line is formed at a sub-micron interval by photo etching process. When the white color light is uniformly controlled not depending on the wavelength like in the conventional projection-type display device, i.e., when the light quantity incident to the liquid crystal panel is not controlled independently for the red, green, and blue color, the chromaticity characteristic, for example, when the blue and the green gradation are 0 and the red gradation is modulated in an arbitrary way is such that the color purity is lowered as the red gradation is lowered. This is because slight light is projected actually even when the gradation of the liquid crystal panel is 0, i.e., black display and as the main color gradation is lowered, its affect cannot be ignored. Alternatively, as in the conventional projection-type display device, even when the white color light is entirely controlled instead of independent control of red, green, and blue in the light quantity incident to the liquid crystal panel, it is possible to minimize the quantity of light incident to the liquid crystal panel only when all the color gradations are 0, i.e., black display.

For example, when the blue and the green gradations are 0 and the red gradation is modulated in an arbitrary way, the incident light quantity to the respective liquid crystal panels depend on the red gradation. Accordingly, when the red is displayed with low gradation, mixture of the green and blue color light cannot be prevented completely. On the other hand, like in the present invention, when the incident light quantity to the liquid crystal panel is controlled independently for each of the red, the green, and the blue color, it is possible to minimize the light quantity of blue and green color of gradation 0 incident to the liquid crystal panel and control the light quantity of red incident to the red liquid crystal panel according to the gradation of the red liquid crystal panel. Since the light quantities incident to the green and the blue liquid crystal panel are minimum, mixing of the green and the blue color light is very small even when the red is displayed with low gradation and it is possible to obtain a display of a high color purity. In this embodiment, the incident side polarization plate is attached to the liquid crystal panel. However, it is also possible to arrange the incident side polarization plate independently or attach it to the illumination light quantity control element.

One of the effects obtained by the present invention is an effect to extend the service life of the liquid crystal panel.

The present embodiment has been explained mainly as a configuration for independently controlling the incident light quantity to the liquid crystal panel by performing phase control of the illumination light for each of the R, G, B color. As a modified example of the present embodiment, for example, it is possible to provide only the illumination light quantity control element 119 so as to modulate the illumination light quantity of only the B liquid crystal panel 116. The color light most affecting degradation of the liquid crystal panel among the R, G, B colors is B (blue color light). Accordingly, modulation of the illumination light quantity to the B liquid crystal panel 116 in accordance with at least the video signal is significantly effective for increasing the service life of the device.

Another effect of the present embodiment is to prevent coloring of the black display.

As a liquid crystal display method of the transmittance type liquid crystal panel, normally, the twist nematic display method is employed. One of the problems of this display method is that the liquid crystal refraction factor anisotropy wavelength dispersion is greater in the blue side and accordingly, when the same drive voltage is applied to the R, G, B liquid crystal panels, the residual phase difference of the B liquid crystal panel is the greatest and the contrast ratio of the B liquid crystal panel is the lowest. Consequently, when black display is performed, coloring into blue occurs. By employing the present invention, it is possible to significantly improve the substantial contrast ratio of the B liquid crystal panel so as to prevent coloring of the black display.

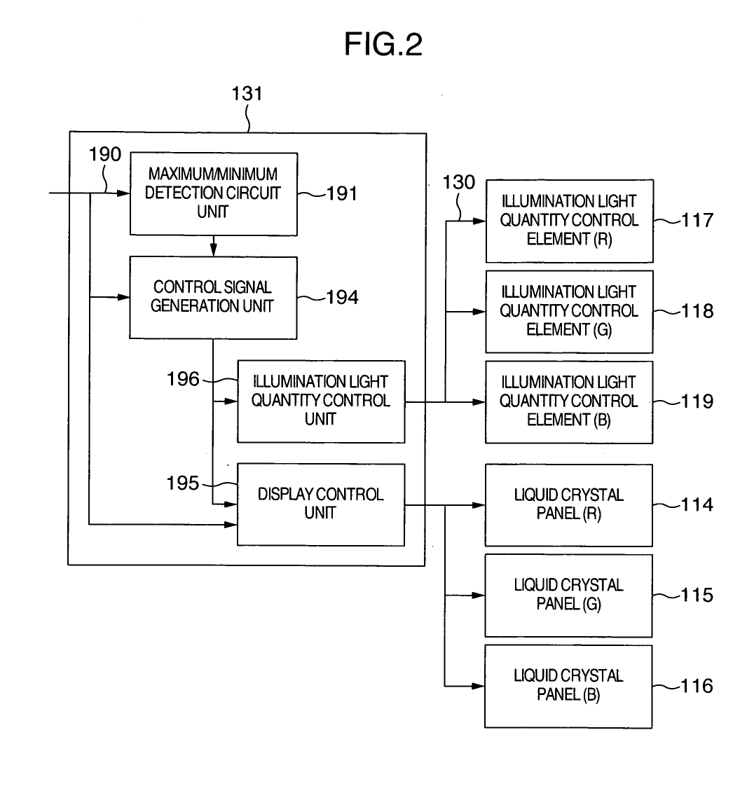

Next, referring to FIG. 2, explanation will be given on the configuration and function of the control circuit 131.

FIG. 2 is a block diagram of the control circuit 131 for generating an image signal and a control signal to be displayed on the liquid crystal panels 114, 115, 116 as display panels according to a video signal 190 including a timing signal and an image data signal and generating a control signal of the illumination light quantity control elements 117, 118, 119 for controlling the illumination light quantity.

The control circuit 131 is formed by at least following blocks: a maximum/minimum detection circuit unit 191 having a circuit unit for detecting a maximum value and a minimum value within one-screen data in a video signal of each of the red color (R), the green color (G), and the blue color (B) and a register for storing the detected data; a control signal generation unit 194 for generating a parameter used for converting the video signal 190 according to the result obtained by the maximum/minimum detection circuit unit 191 and generating a parameter used for controlling the illumination light quantity; a display control unit 195 for controlling the liquid crystal panels (R) 114, (G) 115, (B) 116 according to the control signal generated by the control signal generation unit 194; and an illumination light quantity control unit 196 for controlling the illumination light quantity control elements (R) 117, (G) 118, and (B) 119 according to the control signal generated by the control signal generation unit 194. When the maximum gradation which can be displayed is Lo, the maximum values of the respective colors R, G, B obtained in the maximum/minimum detection circuit unit 191 for an image are L_{RM}, L_{GM}, and L_{BM.}

In the control signal generation unit 194, the gradation conversion magnifications of the respective image signals are given by Lo/L_{RM}, Lo/L_{GM}, and Lo/L_{BM} according to the maximum values L_{RM}, L_{GM}, and L_{BM} of gradation of the respective colors R, G, and B.

In the display control unit 195, according to the gradation conversion magnification obtained by the control signal generation unit 194, the R image is converted so as to extend 0 gradation to L_{RM} gradation to 0 gradation to Lo gradation. Similarly, the G image is converted so as to extend 0 gradation to L_{GM} gradation to 0 gradation to Lo gradation, and the B image is converted so as to extend 0 gradation to L_{BM} gradation to 0 gradation to Lo gradation. Since this is extension conversion, insufficient data is completed by interpolation. By performing these data conversions, it is possible to modulate the illumination light quantity by using the upper limit of the dynamic range of the liquid crystal panel not depending on the video signal and to obtain an effect of improvement of S/N in the low-gradation display.

Moreover, the reduction magnification of the illumination light quantity is decided in the control signal generation unit 194, for example, as follows, considering the gradation characteristic (γ characteristic). The following explanation is given on a case when the relationship between the luminance (I) and the gradation (L) is I=(L/Lo)^{γ}.

When the gradation maximum values of the respective colors R, G, B obtained for a certain image are L_{RM}, L_{GM}, L_{BM}, the reduction magnifications of the illumination light quantity are given as (L_{RM}/Lo)^{γ}, (L_{GM}/Lo)^{γ}, (L_{BM}/Lo)^{γ}, respectively.

According to the reduction magnifications of the illumination light quantity, the illumination light quantity control unit 196 generates control signals of the illumination light quantity control elements (R) 117, (G) 118, and (B) 119.

[Embodiment 2]

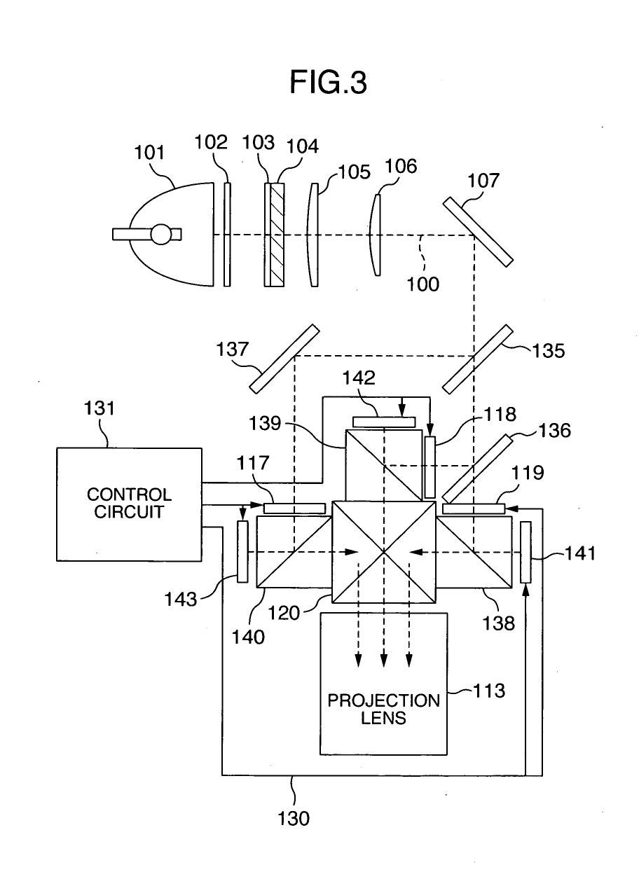

FIG. 3 schematically shows a projection-type display apparatus according to a second embodiment.

The significant difference from the first embodiment is that reflection-type liquid crystal panels are used as the liquid crystal panels 141, 142, 143.

The projection-type display apparatus according to the present embodiment is formed at least by: a light source 101; an illumination optical unit having multi-lenses 102 and 103, a polarization beam splitter array 104, and lenses 105 and 106; a mirror 107; dichroic mirrors 135, and 136; a mirror 137, polarization beam splitters 138, 139, 140; a cross dichroic prism 120; a projection lens 113, liquid crystal panels 141, 142, 143, illumination light quantity control elements 117, 118, 119; and a control circuit 131 for controlling the liquid crystal panels 141, 142, 142 and the illumination light quantity control elements 117, 118, 119 by a control signal 130.

The illumination light quantity control elements 117, 118, 119 of the present embodiment are identical to those in the first embodiment.

The reflection-type liquid crystal panels 141, 142, 143 may be, for example, a method using a monocrystal silicon substrate as an active matrix substrate driving pixels formed in a matrix by employing the nematic liquid crystal of the homeotropic orientation to the liquid crystal layer. Alternatively, it is possible to apply a ferrodielectric liquid crystal layer as a liquid crystal layer.

The illumination light quantity control elements 117, 118, 119 of the present embodiment function as follows. Explanation will be given on an example of blue color illumination light.

The white color light 100 of the three primary color lights emitted from the light source 101 and reflected by the mirror 107 via the illumination optical unit is separated into the red color light and the cyan light by the dichroic mirror 135 and the cyan light is further separated into the green color light and the blue color light by the dichroic mirror 136. The blue color light separated comes into the illumination light quantity control element 119 and is subjected to a phase modulation of a quantity decided by the drive state of the illumination light quantity control element 119. When the retardation of the illumination light quantity control element 119 is almost zero and the phase modulation amount is sufficiently small, the light is reflected by the inner reflection surface of the polarization beam splitter 138 and the illumination light comes into the liquid crystal panel 141.

On the other hand, when the retardation of the illumination light quantity control element 119 is half wavelength, the light which has been subjected to a phase modulation by the illumination light quantity control element 119 is not reflected by the inner reflection surface of the polarization beam splitter 138 and passes through it. Almost no illumination light reaches the liquid crystal panel 141. Thus, by controlling the illumination light quantity control element 119, it is possible to control the light quantity coming into the liquid crystal panel 141. The same applies to the illumination light quantity control elements 117 and 118 for the red and green color illumination light. A problem caused when the present invention is applied is that the polarized component not reaching the liquid crystal panels 141, 142, 143 among the incident light subjected to the phase modulation by the illumination light quantity control elements 117, 118, 119 is significantly increased.

The polarized component not reaching the liquid crystal panels 141, 142, 143 pass through the bonding boundary between the polarization beam splitters 138, 139, 140 without being reflected by them.

Although not depicted in FIG. 3, it is necessary to arrange a member absorbing the polarized component not reaching the liquid crystal panels 141, 142, 143 adjacent to the emission surface of the polarization beam splitter. Unless this configuration is employed, the polarized component not reaching the liquid crystal panels 141, 142, 143 become stray light, which lowers the contrast.

[Embodiment 3]

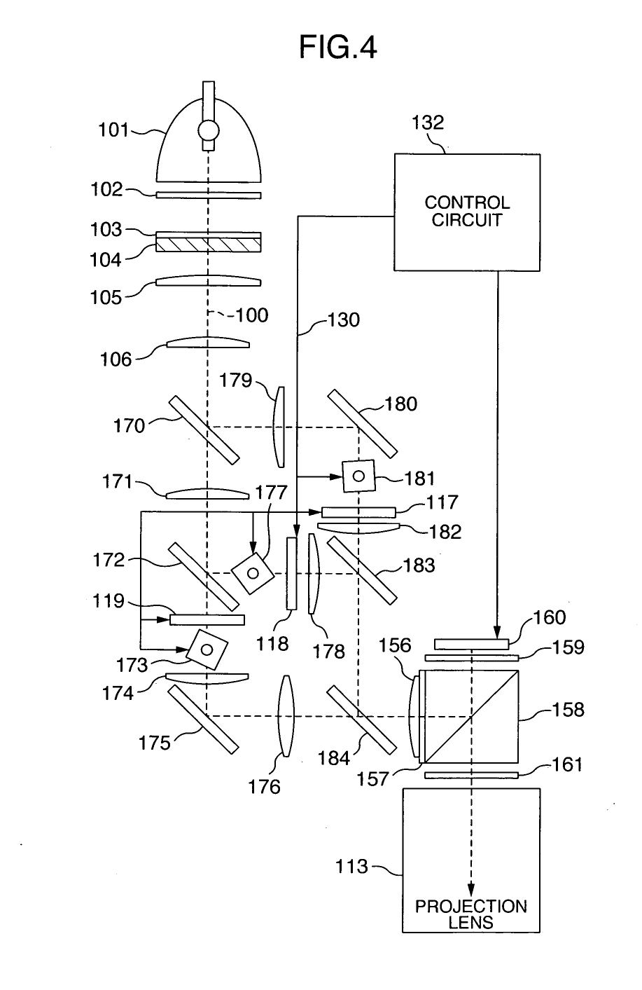

FIG. 4 schematically shows a projection-type display apparatus according to a third embodiment. A significant difference of this embodiment from the second embodiment is that a single-plate color type liquid crystal panel is used as a liquid crystal panel.

The projection-type display apparatus according to the present embodiment is formed at least by: a light source 101; an illumination optical unit having multi-lenses 102 and 103, a polarization beam splitter array 104, and lenses 105 and 106; a color separation optical unit having dichroic mirrors 170 and 172, lenses 171 and 179, and a mirror 180; a scroll illumination optical system having rotary prisms 173, 177, 181, lenses 174, 176, 178, 182, dichroic mirrors 183, 184, and a mirror 175; a lens 156; a polarization plate 157; a polarization beam splitter 158; a phase difference plate 159; a liquid crystal panel 160; a polarization plate 161; a projection lens 113; illumination light quantity control elements 117, 118, 119; and a control circuit 132 for controlling the liquid crystal panel 160 and the illumination light quantity control elements 117, 118, 119 by a control signal 130.

The illumination light quantity control elements 117, 118, 119 in the present embodiment are basically identical to these in the first and the second embodiment.

The reason why analog modulation is required as the modulation method for the illumination light quantity is associated with that the illumination method of the liquid crystal panel in the embodiment is a scroll method using the scroll illumination optical system. The white color light as the three primary color lights from the illumination optical unit formed by the light source 101 to the lens 106 is separated into the red color light and the cyan light by the dichroic mirror 170 and the cyan light is further separated into the green color light and the blue light color by the dichroic mirror 172. The three primary colors separated are subjected optical path modulation by the rotary prisms 173, 177, 181 having different rotary angles relative to one another. Next, the three primary color lights are combined by the dichroic mirrors 183 and 184. The three primary color lights illuminate different areas on the liquid crystal panel 160 and they shift the illumination positions as the time elapses. Moreover, since the three primary color lights simultaneously illuminate the liquid crystal panel 160, the light use efficiency is high even though the single-plate color method is employed.

The rotary prisms 173, 177, 181 rotate as the time elapses and the position of the illumination light of each of the three primary colors on the liquid crystal panel 160 is scrolled as the time elapses. That is, the scroll illumination optical system is configured in such a manner that the illumination positions of the illumination lights of the respective three primary colors are shifted as the time elapses.

The illumination light raster simultaneously illuminates a plurality of lines and the illumination position is scrolled as the time elapses. Accordingly, the illumination light quantity at a certain line is an accumulated light quantity from the tip end of the illumination light raster to its end. When the phase modulation method of the illumination light quantity control elements 117, 118, 119 is analog method, the application to the present embodiment is easier. When applying a digital method, the width modulation is performed with a time width during which the illumination light raster is scrolled by one line.

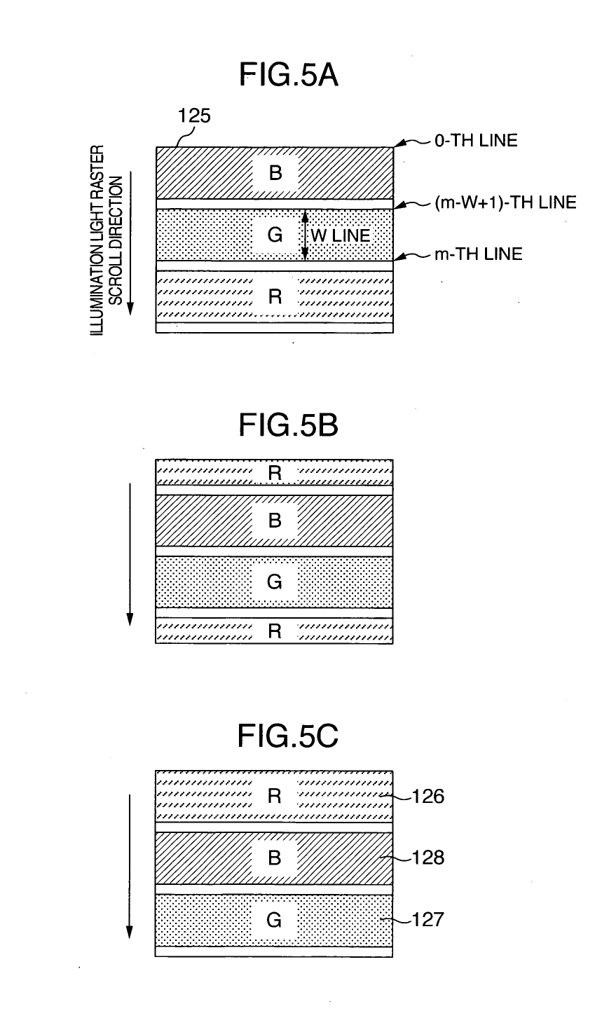

FIGS. 5A to 5C schematically show how the illumination light raster scroll-illuminates the display unit of the liquid crystal panel. The illumination light raster means a shape of the illumination light illuminating a strip-shaped area in the display unit of the liquid crystal panel.

In the scroll illumination method, the display unit of the liquid crystal panel is simultaneously illuminated by the illumination lights of the three primary colors R, G, B.

FIG. 5A shows arrangement of the illumination light raster of thee three primary colors at a certain time and FIG. 5B and FIG. 5C show how the illumination light raster of the three primary colors is scrolled as the time elapses.

Suppose that W is the width of the respective illumination light raster 126, 127, 128 of the three primary colors in the scroll direction expressed by the number of lines. The area illuminated by the illumination light raster having the end of the illumination light raster in the scroll direction, positioned at the m-th line is (m−W+1)-th line to the m-th line. As the illumination light raster is scrolled downward of the display unit, the raster goes out of the display unit, which is again scrolled from the top of the display unit.

FIG. 5B shows that the illumination light raster 126 of the red color light (R) goes out of the bottom of display unit and is again scrolled from the top of the display unit. Here, explanation will be given on the method for calculating the image signal gradation conversion magnification and the illumination light quantity reduction magnification. Moreover, for simplifying the explanation, explanation will be given only on one of the three primary colors. Suppose that the maximum gradation in the image signals of the m-th line is L(m). The maximum gradation L_{M}(m) of each line of the display area corresponding tot he illumination light raster having the scroll-direction end at the m-th line is expressed by Expression (1).
L_{M}(m)=max(L(m−W+1), L(m−W+2), . . . , L(m)) (1)

The function max means the maximum value in the sequence of numbers in the parentheses.

When the maximum gradation which can be displayed is Lo, the wave height value I(m) of the illumination light raster having the scroll-direction end at the m-th line is decided as in Expression (2). The maximum wave height value of the light quantity is normalized to 1.

$$I ( m ) = {( \frac{{L}_{M} ( m )}{{L}_{o}} )}^{γ} \qquad ( 2 )$$

Here, the wave height value Q(m) of the accumulated average light quantity of the illumination light which is scroll-illuminated on the m-th line is expressed by Expression (3). F is an illumination light raster shape factor and is always 1 if the illumination light raster is completely rectangular. The wave height value of the actual illumination light raster end is lowered as compared to that of the center portion and the affect is corrected by this factor.

Expression (3 expresses the average value from the illumination light raster having the scroll-direction end at the m-th line to the illumination light raster shifted by W and having the end at the (m+W−1)-th line. By using Q(m), the gradation conversion magnification B(m) at the m-th line can be expressed by Expression (4).

$$\begin{matrix}Q ( m ) = \frac{{\sum }_{i = m}^{m + W - 1} F ( i - m ) I ( i )}{W} & ( 3 ) \\ B ( m ) = {Q ( m )}^{1 / γ} & ( 4 )\end{matrix}$$

The expression used in this algorithm shows a principle expression and appropriately adapted for digital processing of an image signal when mounted as an actual circuit configuration. Moreover, the image signal gradation conversion magnification and the illumination light quantity reduction magnification should be calculated for each of the three primary colors.

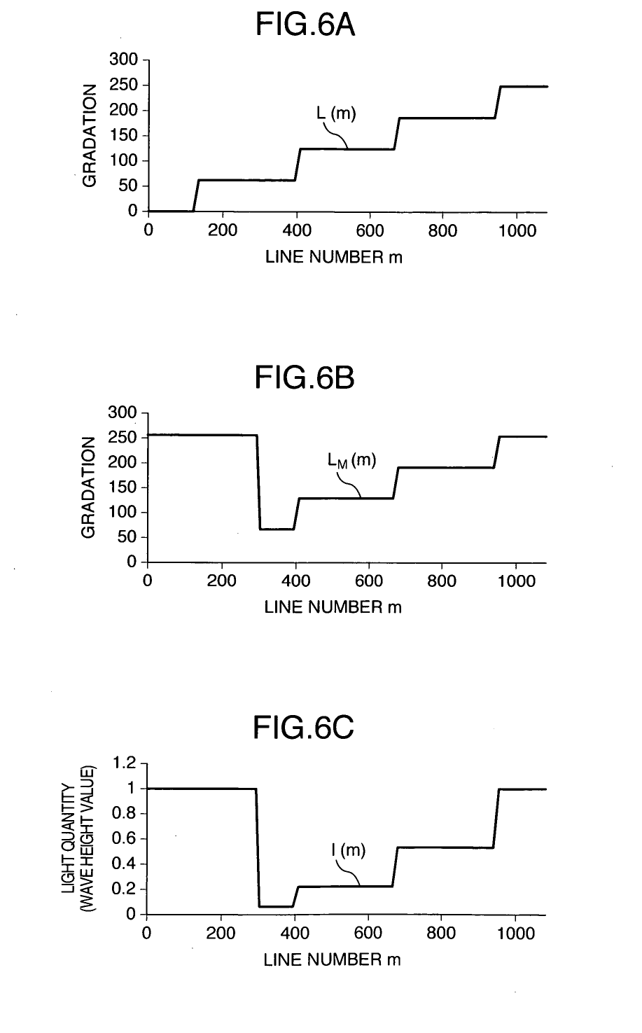

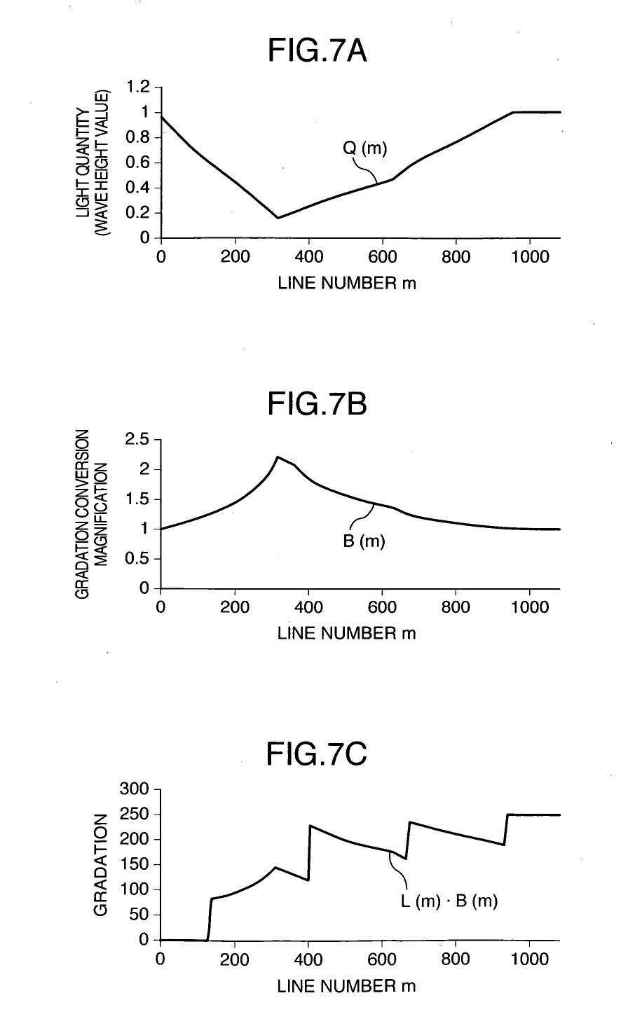

FIGS. 6A to 6C and FIGS. 7A to 7C show examples of results of processing of the image signal by the aforementioned algorithms. In this example, the maximum gradation which can be displayed is 255, the total number of lines is 1080 lines, W is 320 lines, and γ is 2.2.

This example also shows an image signal of a single color among the three-primary colors for simplifying the explanation.

FIG. 6A shows the maximum gradation (L(m)) among the image data of m-th line. As an example of the image signal, a stepwise image signal is shown. FIG. 6B shows the maximum gradation (L_{M}(m)) of each line of the display area corresponding to the illumination light raster having a scroll-direction end at the m-th line. The relationship between L_{M}(m) and L(m) is shown in Expression (1).

Line numbers 0 to about 300 are affected by the split of the illumination light raster to the upper portion and the lower portion. FIG. 6C shows a-light quantity (I(m)) of the illumination light raster having the scroll-direction en d at the m-th line The relationship between the I(m) and L_{M}(m) is shown in Expression (2).

FIG. 7A shows the wave height value (Q(m)) of the accumulated average light quantity of the illumination light scroll-illuminated at the m-th line. FIG. 7B shows a gradation conversion magnification (B(m)) of the m-th line. FIG. 7C shows the maximum value of the m-th line when the image signal data shown in FIG. 6A is con erted by the gradation conversion magnification B(m) shown in FIG. 7B.

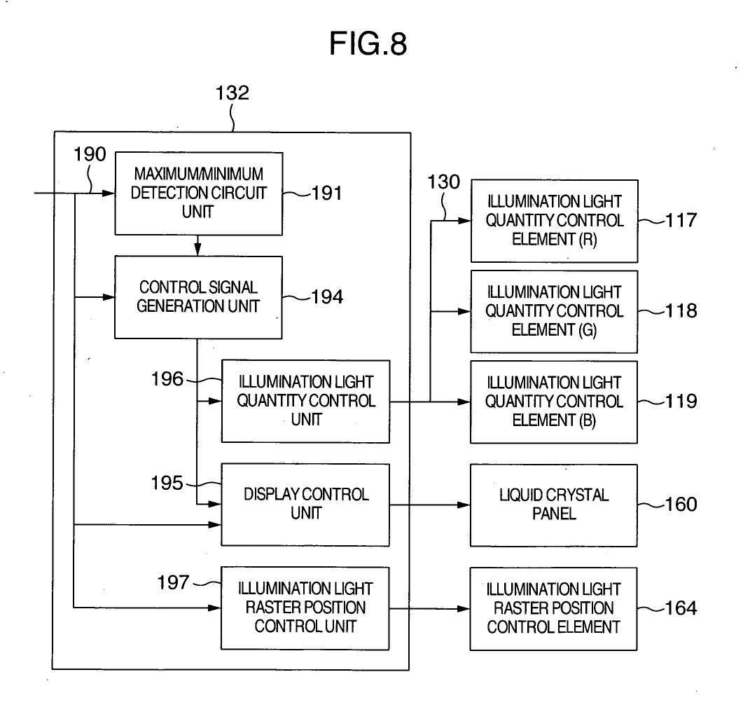

FIG. 8 is a block diagram showing a control circuit 132 according to an embodiment, for controlling the illumination light quantity control elements 117, 118, 119 performing the illumination light quantity control of the scroll illumination to the liquid crystal panel in a single-plate color type projector, a liquid panel 160, and the illumination positions of the respective illumination light raster of each of the three primary colors on the liquid panel 160.

The maximum/minimum detection circuit unit 191 in the control circuit 131 of the present embodiment detects the maximum gradation L(m) for each line, acquires the maximum gradation L_{M}(m) of each line of the display area corresponding to the illumination light raster having the scroll-direction end at the m-th line, and stores it in a memory.

The control signal generation unit 194 calculates Q(m) and B(m) according to the L_{M}(m)and generates a control signal for the display control unit 195 and the illumination light quantity control unit 196. The display control unit 195 converts the image signal of the video signal 190 according to the B(m) corresponding to each color of the three primary colors generated in the control signal generation unit 194 so as to generate reproduction image data and transmits the reproduction image data to the display panel 160 according to the timing signal of the video signal 190. The illumination light quantity control unit 196 generates control signals for controlling the illumination light quantity control elements 117 (R), 118 (G), 119 (B) corresponding to the respective colors of the three primary colors according to the Q(m) corresponding to the respective colors of the three primary colors generated by the control signal generation unit 194 and transmits them to the respective elements. The illumination light raster position control unit 197 controls the illumination position of the illumination light raster of the three primary colors on the display panel according to the timing signal of the video signal 190.

[Embodiment 4]

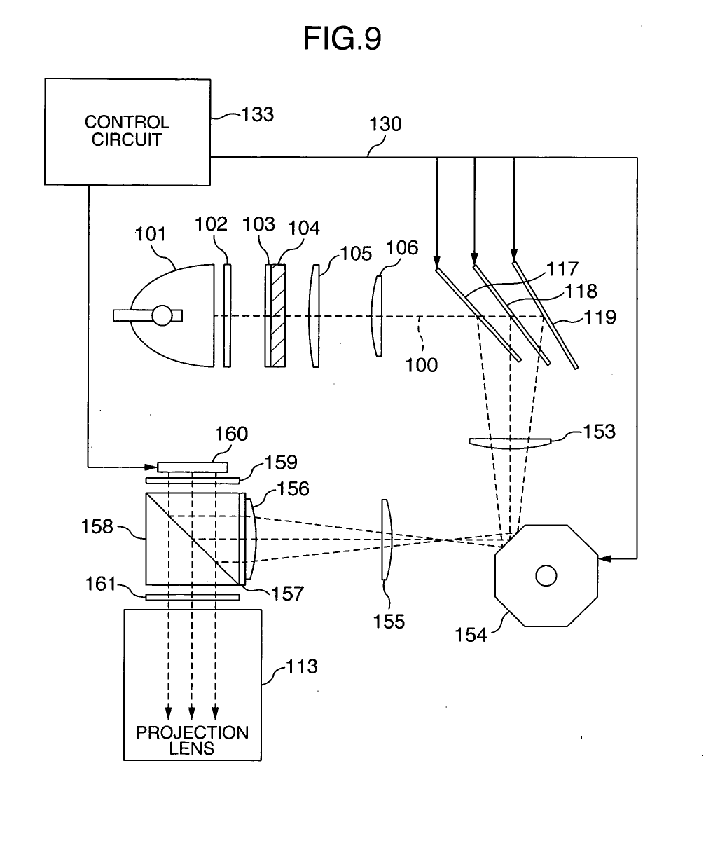

FIG. 9 schematically shows a projection-type display apparatus according to a fourth embodiment.

The projection-type display apparatus of the present embodiment is also a single-plate color type using the reflection type liquid crystal panel 160 like the third embodiment. The difference of the projection-type display apparatus of the present embodiment from the third embodiment is that a polygon mirror is used as the scroll illumination optical system and dichroic reflectance variable mirrors are used as the illumination light quantity control elements 117, 118, 119 performing the light quantity modulation for each of R, G, B.

A specific configuration example of the dichroic reflectance variable mirror as the illumination light quantity control elements 117, 118, 119 in this embodiment may be, for example, holographic grating capable of electrically modulating the diffraction light quantity.

For example, the holographic grating capable of electrically modulating the diffraction light quantity may be holographic polymer diffusion liquid crystal elements or holographic grating elements using the light Kerr effect. Each of the holographic polymer diffusion liquid crystal elements includes two glass substrates, each having a transparent electrode, resin sandwiched by the two glass substrate, and liquid crystal particles cyclically distributed in the resin with orientation in the direction parallel to the glass substrates. The illumination light coming into the optical element becomes a reflected light having light of a particular wavelength range diffracted by the holographic grating formed by the cyclically distributed liquid crystal particles when no voltage is applied. The light of the wavelength region not diffracted transmits. On the other hand, when sufficient voltage is applied, there arises no difference between the refraction factors of the liquid crystal particles and resin for the illumination light and the light of all the wavelength regions transmits. By setting the voltage to an arbitrary value between the aforementioned two states, it is possible to continuously control the reflection light quantity of a particular wavelength range.

Another configuration example of the dichroic reflectance variable mirror as the illumination light quantity control elements 117, 118, 119 may be holographic grating elements using the Kerr effect.

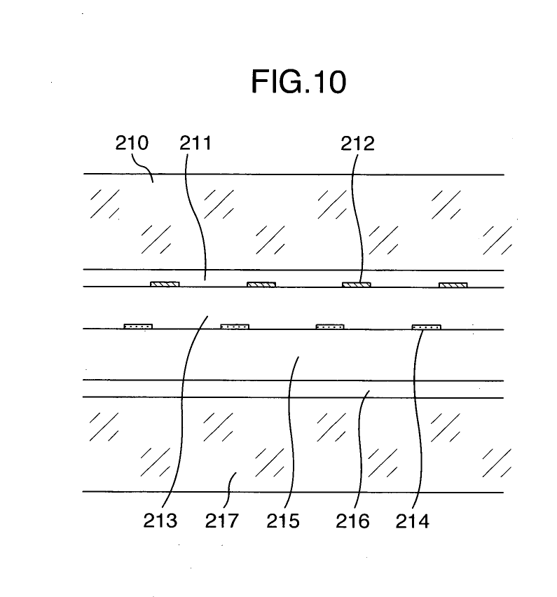

FIG. 10 is a cross sectional view of the holographic grating element using the Kerr effect as a configuration example of the dichroic reflectance variable mirror.

After a transparent electrode group 214 is formed in a comb shape on an electro-optical material substrate 215, an electro-optical material thin film 213 is formed by liquid crystal epitaxial growth method. Furthermore, a comb-shaped transparent electrode group 212 is formed at the position horizontally shifted from the comb-shaped transparent electrode group 214. Transparent substrates 210, 217 are bonded to the both surfaces of the substrate via adhesive layers 211, 216, thereby forming a dichroic reflectance variable mirror.

In each of the dichroic reflectance variable mirrors, the pitch of the transparent electrode groups 212, 214, horizontal shift amount of the transparent electrode groups 212, 214, and the film thickness of the electro-optical material thin film 213 are designed so that light of a predetermined wavelength band is reflected in a predetermined angle direction.

By applying voltage between the transparent electrode groups 212 and 214, a refraction factor distribution is generated in the electro-optical material thin film 213 so as to form holographic diffraction grating. According to the voltage, intensity of the diffraction light (reflected light) is modulated in analog way. The specific material candidates of the electro-optical thin film 213 may be KTN(KTa₁₋ₓNbₓO₃), LiTaO₃, KNbO₃, SBN, BaTiO₃, PLZT, and the like.

[Embodiment 5]

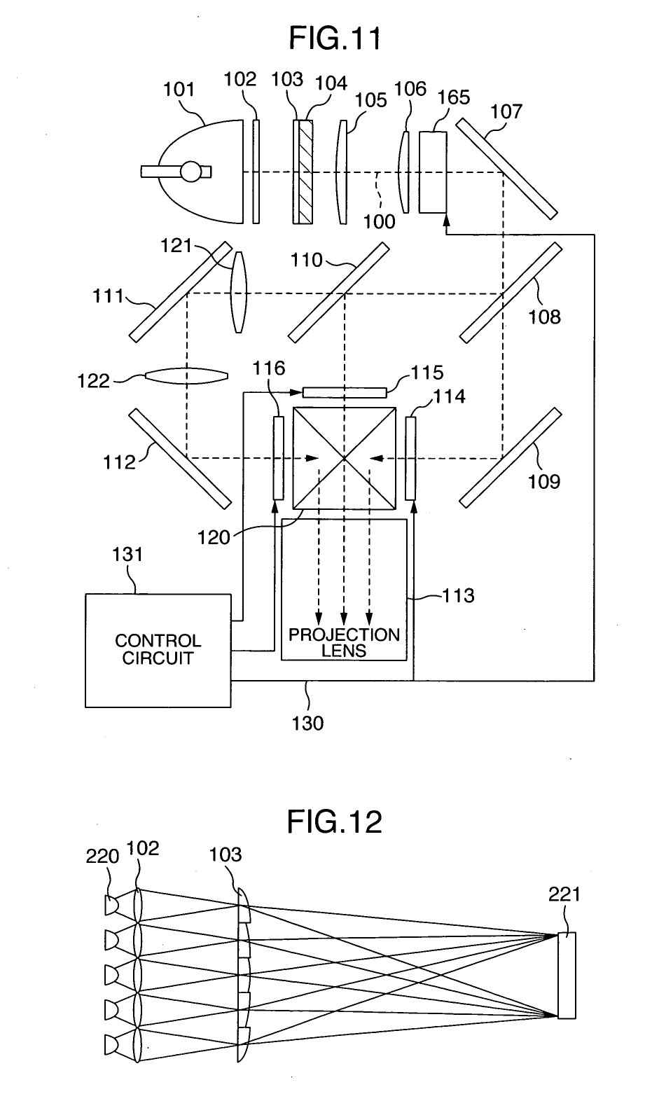

FIG. 11 schematically shows a projection-type display apparatus according to a fifth embodiment.

The projection-type display apparatus of the present embodiment is also a 3-plate type having liquid crystal panels 114, 115, 116 for the respective R, G, B like the first embodiment. However it is different from the first embodiment in that a color selection light modulation element 165 using a combination of a retarder stack element and a liquid crystal element is employed as the illumination light quantity control element performing the light quantity modulation for each of R, G, B.

A liquid crystal cell sandwiched by the two retarder stack elements forms one stage. By continuously using the three stages corresponding to the different primary colors of the three primary colors, it is possible to modulate the phase state for each of the three primary colors independently from one another. The method using the color selection light modulation element 165 of the present embodiment may be applied to the 3-plate type optical system based on the reflection type liquid crystal panel.

It is also possible to arrange a polarization plate before and after the color selection light modulation element 165. However, the polarization plate of the incident side may be omitted since the incident light is polarized in advance by the polarization conversion optical system formed by the multi-lenses 102, 103 and the polarization beam splitter array 104. The polarization plate of the outgoing side may also be omitted because it is replaced by the polarization plate arranged at the incident side of the liquid crystal panel.

[Embodiment 6]

FIG. 12 shows a light source of the projection-type display apparatus according to an embodiment.

This embodiment is characterized by the light source using light emitting diodes (LED) of the three primary colors. The light source of the present embodiment includes a light emitting diode 220 arranged in an array, a multi-lens 102 as a first lens array arranged to correspond to each of the light emitting diodes, and a multi-lens 103 as a second lens array. The lights emitted from the light emitting diodes are collected by the corresponding first lens array and irradiated by the second lens array to the entire liquid crystal display element 221. Thus, it is possible to obtain a light source having a uniform illumination intensity distribution on the liquid crystal display element 221.

The present invention may be applied to a rear surface projection-type display apparatus for a television and a front projector for projecting a video onto a screen provided outside a device.

It should be further understood by those skilled in the art that although the foregoing description has been made on embodiments of the invention, the invention is not limited thereto and various changes and modifications may be made without departing from the spirit of the invention and the scope of the appended claims.

1. A projection-type display apparatus comprising:
a light source emitting three primary colors,
a display panel,
a control circuit which controlls the display panel,
an illumination optical unit which illuminates the display panel with the light emitted from the light source,
an illumination light quantity control element which modulates the illumination light quantity of each of the three primary colors, and
a projection lens which projects the light modulated by the display panel,
wherein the control circuit generates a control signal for controlling the display panel according to an inputted video signal,
the illumination light quantity control element modulates the illumination light quantity according to the control signal at least in one of the illumination lights of the three primary color lights, and
the illumination light quantity is modulated by using the upper limit of the dynamic range of the display panel not depending on the video signal.

2. The projection-type display apparatus as claimed in claim 1, the apparatus further comprising a color separation optical unit which separates the three primary color lights into red, green, and blue primary color lights,
wherein the illumination light quantity control element is arranged on the optical path of at least one of the three primary colors at a position before each color light separated by the color separation optical unit comes into the display panel.

3. The projection-type display apparatus as claimed in claim 2, the apparatus further comprising a polarization bean splitter which reflects the illumination light emitted from the illumination light quantity control element at a reflection surface so as to introduce the light into the display panel.

4. The projection-type display apparatus as claimed in claim 1, wherein the illumination light quantity control element is arranged at a position where the three primary color lights emitted from the light source are on the same optical path.

5. The projection-type display apparatus as claimed in claim 1, wherein
the display panel is a liquid crystal display,
the illumination light quantity control element is a color selection light modulation element modulating phases of the respective three primary color lights independently from one another, and
the color selection light modulation element includes a liquid crystal cell sandwiched by two retarder stacks.

6. The projection-type display apparatus as claimed in claim 1, wherein
the illumination light quantity control element is a liquid crystal cell formed by two glass substrates and a liquid crystal layer sandwiched by the two glass substrates and the retardation corresponding to a particular wavelength range is substantially half wavelength.

7. The projection-type display apparatus as claimed in claim 1, wherein
the control circuit includes:
a maximum/minimum detection circuit unit which detects a maximum value and a minimum value within one-screen data in the respective video signals of red, green, and blue inputted,
a control signal generation unit which generates the control signal according to the maximum value and the minimum value detected by the maximum/minimum detection circuit unit,
a display control unit which controlles the display panel according to the control signal generated by the control signal generation unit, and
an illumination light quantity control unit which controlls the illumination light quantity control element according to the control signal generated by the control signal generation unit.

8. The projection-type display apparatus as claimed in claim 1, the apparatus further comprising a scroll illumination optical system in which each color light of the three primary colors illuminates a different part of the display panel and their illumination positions are shifted as the time elapses.

9. The projection-type display apparatus as claimed in claim 8, wherein
a wave height value of an illumination light raster is decided by the maximum gradation of a video signal corresponding to an illumination light raster illuminating a strip-shaped range in the display unit of the display panel,
a gradation conversion magnification is decided by the integrated light quantity of the illumination light at each line of the display unit of the display panel, and
the illumination light raster wave height value and the gradation conversion magnification are updated as the illumination light raster is shifted.

10. The projection-type display apparatus as claimed in claim 1, wherein the light source is formed by a plurality of light emitting diodes of the respective three primary colors arranged in an array.

11. A projection-type display apparatus comprising:
a light source which emitts three primary colors,
a liquid crystal panel,
a control circuit which controlls the liquid crystal panel,
an illumination optical unit which illuminates the liquid crystal panel with the light emitted from the light source,
a plurality of illumination light quantity control elements which modulates the illumination light quantity of each of the three primary colors, and
a projection lens which projects the light modulated by the liquid crystal panel,
wherein the control circuit generates a control signal for controlling the liquid crystal panel according to an inputted video signal,
the illumination light quantity control elements separate the three primary color light into red, green, and blue color lights, modulates the illumination light quantity according to the control signal in each color light separated, uses the upper limit of the dynamic range of the liquid crystal panel not depending on the video signal.

12. The projection-type display apparatus as claimed in claim 11, wherein
the plurality of illumination light quantity control elements are dichroic mirrors having different angles from one another, and
at least one of the dichroic mirrors is a dichroic reflectance variable mirror which controlls a reflected light quantity of a particular wavelength range.

13. The projection-type display apparatus as claimed in claim 11, the apparatus further comprising a polygon mirror which modulates optical paths of the respective color lights color-separated by the illumination light quantity control elements.

14. The projection-type display apparatus as claimed in claim 12, wherein the dichroic reflectance variable mirror is a field control type holographic grating element formed by a polymer diffusion type liquid crystal layer having liquid crystal droplet layers cyclically arranged in a transparent polymer medium which is sandwiched by glass substrates having transparent electrodes.

15. The projection-type display apparatus as claimed in claim 12, wherein the dichroic reflectance variable mirror is a field control type holographic grating element formed by an electro-optical material thin film having a refraction factor varying according to voltage and sandwiched by two comb-shaped electrodes arranged so as not to be superimposed on each other.

16. The projection-type display apparatus as claimed in claim 11, the apparatus further comprising a scroll illumination optical system in which the respective color lights of the three primary colors illuminate different parts of the liquid crystal panel and the illumination positions are shifted as the time elapses.

17. The projection-type display apparatus as claimed in claim 8, wherein
a wave height value of an illumination light raster is decided by the maximum gradation of a video signal corresponding to an illumination light raster illuminating a strip-shaped range in the display unit of the display panel,
a gradation conversion magnification is decided by the integrated light quantity of the illumination light at each line of the display unit of the display panel, and
the illumination light raster wave height value and the gradation conversion magnification are updated as the illumination light raster is shifted.

18. The projection-type display apparatus as claimed in claim 8, wherein the light source is formed by a plurality of light emitting diodes of the respective colors of the three primary colors arranged in an array.
